(19) United States
(12) Patent Application Publication
(10) Pub. No.: US 2008/0315161 A1
(43) Pub. Date: Dec. 25, 2008

(54) Electrochemical Device-Oriented Electrode Material and Production Method Thereof , as Well as Electrochemical Device-Oriented Electrode and Electochemical Device

(75) Inventors: Daisuke Endo, Kyoto (JP); Tokuo Inamasu, Kyoto (JP); Toshiyuki Nukuda, Kyoto (JP)

Correspondence Address: KANESAKA BERNER AND PARTNERS LLP, 1700 DIAGONAL RD, SUITE 310, ALEXANDRIA, VA, 22314-2848, US

(73) Assignee: GS YUASA CORPORATION, Kyoto-shi (JP)

(21) Appl. No.: 11/658,079

(22) PCT Filed: Jul. 27, 2005
(86) PCT No.: PCT/JP2005/014155

§ 371 Date: Jan. 22, 2007

(30) Foreign Application Priority Data
Jul. 28, 2004 (JP) 2004-219499

(51) Int. Cl. H01B 1/08

(52) U.S. Cl. 252/519.3

(57) ABSTRACT

It is an object of the present invention to provide an electrochemical device adopting lithium titanate as an active material and having a sufficient output characteristic. It is another object of the present invention to provide a production method of an electrode material, an electrode, and a production method of the electrode material, to be used for the device.

There can be obtained an electrochemical device-oriented electrode material, containing 90% or more of lithium titanate, and having a bulk density of 1.5 g/cm³ or more and a volume resistivity of 16 Ω·cm or less, by mixing the lithium titanate with an organic substance followed by heat treatment. Usage thereof allows for achievement of the objects.

### TECHNICAL FIELD

The present invention relates to an electrochemical device-oriented electrode material mainly including lithium titanate and a production method thereof, as well as an electrochemical device-oriented electrode and an electrochemical device each adopting the electrode material, and particularly to a technique for providing electron conductivity to particles of lithium titanate. Herein, the term “electrochemical device” refers to an electrochemical cell having a pair of electrodes and an electrolyte, such as: nonaqueous cells such as lithium primary cell, lithium secondary cell, and lithium ion cell; aqueous cells; fuel cells; electric double layer capacitors; and the like.

### BACKGROUND ART

Since nonaqueous electrolyte cells such as lithium secondary cells exhibit higher energy densities and provide higher voltages, they are widely used as electric-power sources for small-sized mobile terminals, vehicular communications apparatus, and the like. Lithium secondary cells each comprises: a positive electrode including a positive electrode-oriented active material as a main component capable of releasing and storing lithium ions associatedly with charge and discharge; a negative electrode capable of storing and releasing lithium ions associatedly with charge and discharge; and an electrolyte comprising a lithium salt and an organic solvent.

There has been proposed a method for improving an electron conductivity at a surface of an active material particle.

Disclosed in a patent-related reference 1 is a technique to add a pitch into a transition metal-boron complex such as VBO₃, TiBO₃, or the like, and to firingly form them into electrode-oriented active material particles having a higher electric conductivity. Further, disclosed in a patent-related reference 2 is a method for mixing a precursor of LiFePO₄ and a carbonaceous precursor, followed by drying and firing, to obtain LiFePO₄ having a surface coated with a carbonaceous substance.

It is further known that lithium titanate can be used as a negative electrode-oriented active material for a lithium secondary cell (see patent-related reference 3, for example).

Patent-related reference 1: JP-2003-157842A

Patent-related reference 2: JP-2003-292309A

Patent-related reference 3: JP-2004-095325A

### DISCLOSURE OF THE INVENTION

### Problem to be Solved by the Invention

Since lithium titanate is less in crystal structure change and less in volume strain accompanying to storage and release of lithium ions so that a lithium secondary cell adopting lithium titanate as an active material is extremely excellent in a repeated charge and discharge performance, lithium secondary cells are the cell types having an extremely higher industrial applicability from now on because they are suitable for an installed usage as a battery for an uninterruptible power source, a battery for electric-power storage, or the like where importance is given to a longer service life property for eliminating the necessity of maintenance and exchange over a long period of time, rather than to a higher energy density property. However, those cells adopting lithium titanate as active materials have been insufficient in output characteristic.

The present invention has been carried out in view of the above-mentioned problems, and it is an object of the present invention to provide an electrochemical device adopting lithium titanate as an active material to thereby possess a sufficient output characteristic. It is another object of the present invention to provide an electrode adopting lithium titanate as an active material, capable of providing an electrochemical device having a sufficient output characteristic.

The following are assumable as reasons of the fact that those cells adopting lithium titanate as active materials are insufficient in output characteristic. Ti⁴⁺ constituting lithium titanate has no “d” electrons, and is thus classified into a nonconductor. It is thus necessary to mix lithium titanate with a large amount of electroconductive material so as to use the former in an electrochemical device-oriented electrode. However, simply mixing lithium titanate with a large amount of electroconductive material fails to attain a sufficient output characteristic of an electrochemical device adopting lithium titanate as its electrode-oriented active material. To solve this problem, it is required for a particle of lithium titanate to have a surface covered by an electroconductive material at a high density. The present inventors have experimented the techniques described in the patent-related references 1 and 2 in an attempt to provide electrical conductivity, but failed to do so in an effective manner even by applying these techniques to lithium titanate. It is thus still another object to be solved by the present invention, to offer lithium titanate effectively provided with electrical conductivity.

### Means for Solving Problem

The configuration and the functions and effects of the present invention are as follows. However, the mechanism of functions includes assumption, and the present invention is not restricted depending on the result of the mechanism of functions.

The present invention resides in an electrochemical device-oriented electrode material containing 90% or more of lithium titanate, and having a bulk density of 1.5 g/cm³ or more and a volume resistivity of 16 Ω·cm or less.

In the present specification, measurement conditions of a volume resistivity and a bulk density are as follows. Measurements are conducted in air at a room temperature between 20° C. inclusive and 25° C. inclusive. FIG. 1 shows a conceptional view of a device used for measuring a volume resistivity. There is prepared a pair of measurement proves 1A and 1B. The measurement proves 1A and 1B comprise: cylinders made of stainless steel (SUS304) having diameters of 6.0 mm (±0.05 mm) and having measurement surfaces 2A and 2B provided by flattening and surface finishing one ends of the cylinders, respectively; and pedestals 3A and 3B made of stainless steel, to which the other ends of the cylinders are vertically coupled, respectively. The pedestals 3A and 3B are provided with measurement terminals 4A and 4B for facilitated connection of measurement lead wires thereto, respectively. In turn, there is prepared a lateral body 6 provided by forming a through-hole 5 at a center of a cylinder made of polytetrafluoroethylene in a manner that the through-hole is adjusted in inner diameter and ground such that the applicable cylinder made of stainless steel is allowed to naturally and slowly fall in air by a gravity through the through-hole. The lateral body 6 has an upper surface and a lower surface, both ground flatly and smoothly.

Prior to measurement, the measurement surfaces 2A and 2B are duly ground, finally ground by a sand paper of No. 1500, and dried. This operation is conducted for each different sample to be measured. The measurement prove 1A is installed on a horizontal table in a manner to upwardly direct the measurement surface 2A, and the cylindrical portion of the measurement prove 1A is inserted into the through-hole 5 of the lateral body 6 such that the lateral body 6 is covered onto the cylindrical portion. The other measurement prove 1B is inserted into the through-hole 5 from the above while the measurement surface 2B is directed downwardly, thereby bringing a distance between the measurement surfaces 2A and 2B into a zero state. At this time, there is measured a gap to be caused between the pedestal 3B of the measurement prove 1B and the lateral body 6.

Next, the measurement prove 1B is drawn out, followed by delivery of a powder of measurement target sample having a known weight into the through-hole 5 from the above by a spatula, and then the measurement prove 1B is again inserted into the through-hole 5 from the above while downwardly directing the measurement surface 2B of the measurement prove 1B. The delivery amount of the measurement target sample is to be between an amount for sufficiently covering the flattened surface portion, and an amount by which the distance between the measurement surfaces 2A and 2B becomes less than 3 mm after insertion of the measurement prove 1B. There is interposed a gap gauge 7 of 2.5 mm or less between the pedestal 3B of the measurement prove 1B and the lateral body 6, and the measurement prove 1B is pressurized from the above by a manual hydraulic press having a pressure gauge. At this time, the pressurization is conducted until an indicated value of a pressure scale of the press reaches 100 kgf/cm² in an extent that the indicated value does not exceed 100 kgf/cm² while checking the indicated value, and then the indicated value of 10 kgf/cm² is to be kept. Here, the pressure of the press is not fully applied to the measurement sample, because the pressurization is conducted while clamping the gap gauge 7 between the pedestal 3B of the measurement prove 1B and the lateral body 6. Connected between the measurement terminals 4A and 4B is a contact resistance meter capable of measuring an AC impedance at a frequency of 1 kHz, thereby measuring the resistance value. There are then recorded the resistance value indicated by the contact resistance meter and the distance between the measurement surfaces 2A and 2B. Next, measurements are repeated by sequentially using thinner gap gauges while sequentially decreasing the distance between the measurement surfaces 2A and 2B by 0.2 mm as compared with that in each previous measurement, in an extent that the distance between the measurement surfaces 2A and 2B can be decreased down to a limitation of 0.4 mm.

Next, there is calculated a volume resistivity ρ (Ω·cm) in accordance with the following equation (1). Further, there is calculated a bulk density (g/cm³) in accordance with the following equation (2). In the equations, S represents an area (cm²) of the measurement surface, d represents a distance (cm) between the measurement surfaces 2A and 2B, R represents a resistance value (Ω) indicated by the contact resistance meter, and w represents a weight (g) of the delivered measurement sample.

volume resistivity ρ(Ω·cm)=R·S/d (equation 1)

bulk density(g/cm³)=w/(S·d) (equation 2)

According to such a configuration, there can be provided an electrochemical device-oriented electrode material capable of providing an electrochemical device having a sufficient output characteristic, because electrode materials containing lithium titanate have higher bulk densities and lower volume resistivities, respectively. Among them, preferable are those which are allowed to have bulk densities of 1.6 g/cm³ or more and volume resistivities of 12 Ω·cm or less based on the above described measurement method, and more preferable are those which are allowed to have bulk densities of 1.7 g/cm³ or more and volume resistivities of 10 Ω·cm or less.

Further, the electrochemical device-oriented electrode material is characterized in that carbon materials are present on surfaces of lithium titanate particles. Namely, carbon materials are attached or coated onto surfaces of particles made of lithium titanate.

Since carbon materials are present on surfaces of lithium titanate particles, the lithium titanate particles are effectively provided with electrical conductivity. Further, since carbon materials are present on surfaces of lithium titanate particles to thereby largely increase surface areas thereof, contact thereof with an electrolyte can be made excellent and a high ratio charge and discharge performance can be improved.

Further, the lithium titanate is characterized in that the same has a spinel structure and is represented by a composition formula of Li₄Ti₅O₁₂-Such a configuration allows for provision of an electrochemical device-oriented electrode material capable of establishing an electrochemical device having a longer service life by utilizing a feature of Li₄Ti₅O₁₂ excellent in discharge/charge cycle performance.

Note that although numbers of atoms of respective elements included in the composition formula of Li₄Ti₅O₁₂ may vary depending on loaded amounts of starting materials to be used upon synthesis of lithium titanate, such variants are also embraced within the scope of the present invention insofar as a peak derived from TiO₂ is not observed as a separate phase on an X-ray diffraction diagram having a maximum scale corresponding to the full scale in case of conduction of X-ray diffraction measurement.

Moreover, the present invention resides in an electrochemical device-oriented electrode including the above-described electrochemical device-oriented electrode material.

Such a configuration allows for provision of an electrochemical device-oriented electrode capable of providing an electrochemical device having a sufficient output characteristic.

Furthermore, the present invention resides in an electrochemical device adopting the above-described electrochemical device-oriented electrode.

Such a configuration allows for provision of an electrochemical device having a sufficient output characteristic.

Further, the present invention resides in a production method of an electrochemical device-oriented electrode material characterized in that the method comprises the steps of:

mixing lithium titanate with an organic substance into a mixture, and

conducting a heat treatment of the mixture, thereby obtaining the above-described electrochemical device-oriented electrode material.

Such a configuration allows for provision of a convenient production method of an electrochemical device-oriented electrode material capable of providing an electrochemical device having a sufficient output characteristic.

Moreover, the production method of the present invention is characterized in that the heat treatment is conducted by subjecting the mixture to a heat treatment process in the presence of a solvent.

Although the mixture of the lithium titanate and organic substance to be subjected to the heat treatment may be obtained by dry mixing, or by dissolving or dispersing the organic substance in a solvent to thereby wet mix it with lithium titanate followed by drying, it is possible to apply the carbon material to surfaces of lithium titanate particles in a specifically excellent manner when the mixture in the state of existence of the solvent after wet mixing is directly subjected to the heat treatment process. Such excellent application is assumed to be achieved by virtue of an increased uniformity of application of the carbon material onto surfaces of lithium titanate particles, because direct subjection of the mixture in the existence of solvent to the heat treatment process allows for decrease of a risk where the organic material is maldistributed around lithium titanate particles upon heat treatment. This effect is contrastive to the noted points in the related art such as the patent-related references 1, 2 and the like where a solvent is required to be carefully removed before firing, and this effect is assumed to be related to a fact that the surface state of lithium titanate particles of the present invention is largely different from those in other typical active materials to be used as lithium cell-oriented active materials. Here, although the solvent will do insofar as the same is capable of dissolving or dispersing the organic substance therein, it is desirable to select one from those solvents capable of dissolving the organic substance therein because the organic substance is then allowed to be arranged to more uniformly cover surfaces of lithium titanate particles cooperatively with the solvent. Examples of the solvents include water, ethanol, methanol, acetonitrile, acetone, toluene, and the like, without limited thereto.

Moreover, the production method of the present invention is characterized in that the solvent is a nonaqueous solvent.

Although the solvent may be water, selection of the nonaqueous solvent specifically allows to remarkably decrease a risk that lithium elements constituting lithium titanate are eluted into an aqueous solution due to an ion-exchange reaction with protons, thereby enabling to decrease a risk that layers acting as resistance components are formed on surfaces of lithium titanate particles due to the ion-exchange reaction. From this standpoint, it is desirable to select the organic substance to be mixed with lithium titanate upon heat treatment, from among those soluble in nonaqueous solvents.

Furthermore, the production method of the present invention is characterized in that the organic substance has a phenolic structure.

Such a configuration allows for application of the carbon material to surfaces of lithium titanate particles in a reliable manner at a high density. Although it is not necessarily apparent for the reason that a specifically excellent result is obtained upon adoption of an organic substance having a phenolic structure as the above described organic substance, it is assumed that such a result is related to a carbon atom density of molecules of the organic substance having the phenolic structure, or related to a fact that the molecular structure of the organic substance having the phenolic structure is apt to form an electron conduction path upon carbonization. The ratio (molecular weight ratio) of the phenolic structure to the molecule of the organic substance is desirably 20% or more, and more desirably 40% or more. Desirable as the organic substance having the phenolic structure are resins, and particularly bisphenol type resins.

### EFFECT OF THE INVENTION

According to the present invention, it is possible to provide an electrochemical device having a sufficient output characteristic by adopting lithium titanate as an active material. It is also possible to provide an electrode adopting lithium titanate as an active material, capable of providing an electrochemical device having a sufficient output characteristic. It is further possible to provide an electrochemical device-oriented electrode material comprising lithium titanate and a production method thereof, the material being usable in an electrochemical device having a sufficient output characteristic.

### BRIEF DESCRIPTION OF DRAWINGS

FIG. 1 is a conceptional view of a device used for measurement of volume resistivity.

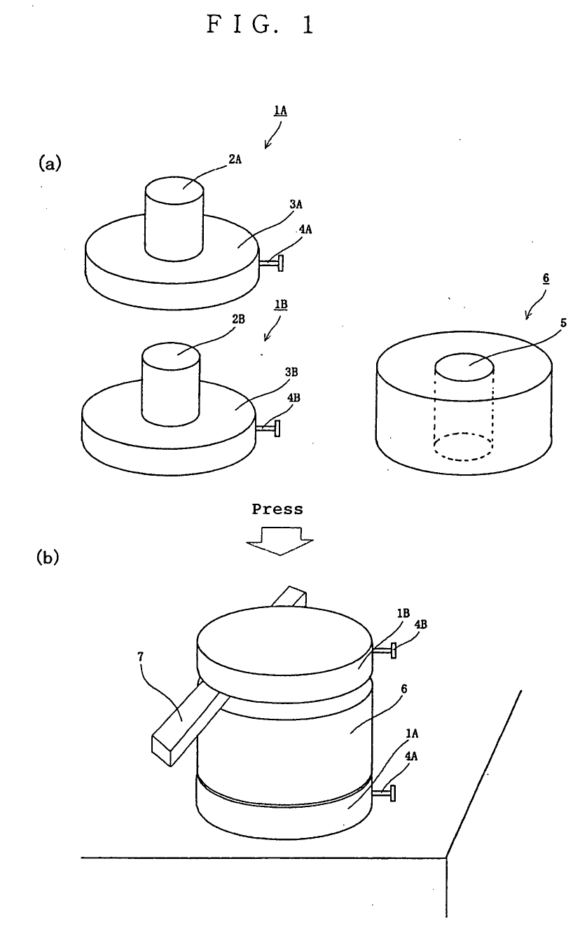

FIG. 2 is a graph of output characteristics of a present invention electrochemical device and a comparative electrochemical device.

### EXPLANATIONS OF LETTERS OR NUMERALS

1A, 1B measurement prove
2A, 2B measurement surface
3A, 3B pedestal
4A, 4B measurement terminal
5 through-hole
6 lateral body
7 gap gauge

### BEST MODES FOR CARRYING OUT THE INVENTION

It is desirable that a mixing ratio of lithium titanate and an organic substance in a mixture to be subjected to a heat treatment is set to be such that the ratio of the organic substance present in the mixture thereof is between 5 wt % inclusive and 70 wt % inclusive. Ratios of the organic substance of 5% or more avoid excessively less amounts of the carbon material to be applied to surfaces of lithium titanate particles, thereby enabling provision of a sufficient electrical conductivity to lithium titanate particles. 10% or more is more preferable. Further, ratios of the organic substance of 70% or less allows for decrease of a risk that an excessively large application amount of the carbon material causes a decreased volumetric energy density of an electrode, and 60% or less is more desirable.

Although desirable amounts of solvents largely vary depending on kinds of organic substances in case that a solvent is caused to be present in a mixture of lithium titanate and an organic substance to be subjected to a heat treatment, it is preferable to appropriately adjust the amount such that the mixture of lithium titanate and organic substance is brought into a uniform slurry state in appearance.

The organic substance to be mixed with the lithium titanate upon heat treatment is desirably one having a vaporization temperature of 500° C. or higher, thereby enabling to largely decrease a risk that the organic material is vaporized upon heat treatment to obstruct application of the carbon material onto surfaces of lithium titanate particles. Further, the organic substance is desirably to have a carbonization temperature of 550° C. or lower, thereby enabling to largely decrease a risk that carbonization of the organic material upon heat treatment is made insufficient to obstruct application of the carbon material onto surfaces of lithium titanate particles.

Although the organic substance to be mixed with the lithium titanate upon heat treatment is not particularly limited, it is exemplarily possible to desirably use polyvinyl alcohol, resins having phenolic structure, and the like. Among them, resins having phenolic structure soluble in an organic solvent are desirable, as compared with polyvinyl alcohol which is water-soluble.

The heat treatment is to be preferably conducted in an inert atmosphere such as argon gas, nitrogen gas, or the like. When the atmosphere for the heat treatment includes a large amount of oxygen, there is excessively progressed an oxidational decomposition reaction of the organic substance (theoretically, the organic substance may be decomposed up to carbon dioxide), thereby resultingly failing to coat surfaces of lithium titanate particles with the carbonaceous material. In the present invention adopting lithium titanate as an active material, a titanium element has no electrons in a “d” orbit, so that the lithium titanate is never reduced even by conducting the heat treatment in an inert atmosphere. From this standpoint, the oxygen concentration of the atmosphere for the heat treatment is preferably 10% or less, and more preferably 5% or less.

Excessively lower heat treatment temperatures lead to an insufficient progress of carbonization of the organic substance, thereby possibly leading to an insufficient provision of electrical conductivity and an insufficiently increased bulk density. In turn, excessively higher heat treatment temperatures lead to an excessively progressed decomposition reaction, thereby resultingly failing to coat surfaces of lithium titanate particles with the carbonaceous material. From this standpoint, the heat treatment temperature is desirably between 350° C. inclusive and 600° C. inclusive.

The heat treatment period of time is not particularly limited, and even excessively longer heat treatment periods of time lead to small possibilities of affection on electrochemical performance. In turn, although the temperature elevation period of time upon heat treatment is not particularly limited, it is desirable to adopt a value of 10° C./min or more in case of subjecting the mixture to a heat treatment process in the presence of a solvent.

### EXAMPLES

The lithium titanate used in the following Examples and Comparative Examples is obtained by mixing LiOHH₂O and TiO₂ (anatase type) at a ratio of Li:Ti=4:5 (molar ratio) followed by firing in an atmospheric air at 800° C., has a spinel structure and is represented by a composition formula of Li₄Ti₅O₁₂. Note that it has an averaged particle diameter of 0.92 μm and a BET specific surface area of 3.46 m²/g, and it looks white.

### Comparative Example 1

The above-described lithium titanate is regarded as a comparative electrode material 1.

### Example 1

As an organic substance to be mixed with the lithium titanate, there was adopted a bisphenol A type resin (product number: CY230, molecular weight ratio of phenol structure: assumed to be about 54%; produced by Nagase ChemteX Corporation), and there was obtained a slurry-like mixture containing the lithium titanate, the organic substance, and a solvent at a weight ratio of 15:15:3. Here, the solvent was a mixture of toluene and dibutyl phthalate. The dibutyl phthalate of them was originally contained in the bisphenol A type resin. 20 g of the slurry-like mixture was flowed into a firing port made of stainless steel, and installed within a tubular furnace having an inner diameter of 70 mm, the temperature was raised up to 600° C. in a nitrogen gas flow atmosphere (flow rate of 500 ml/min) at a temperature rising rate of 10° C./min, followed by holding at the above-described temperature for 12 hours, by natural cooling thereafter still in the nitrogen gas flow atmosphere, and by grinding of the content of the firing port in an agate mortar. In this way, there was obtained an electrochemical device-oriented electrode material according to the present invention. This is regarded as a present invention electrode material 1.

The electrode material looked black, and there were observed a peak of exothermic reaction and a commencement of weight decrease near 400° C. onward as a result of thermogravimetry/differential thermal analysis (TG-DTA) in air. From the TG measurement result and an analysis result of outflow gas upon TG measurement, the present invention electrode material 1 was found to comprise lithium titanate with surfaces having 8.3 wt % of carbon material applied thereto. Additionally, as a result of specific surface area measurement by a BET one-point calibration curve method, the present invention electrode material 1 had a specific surface area of 68.5 m²/g, thereby showing that the same had an increased specific surface area about 20 times as large as that of the lithium titanate used as the starting material. Further, as a result of X-ray diffraction measurement, there was observed only a peak corresponding to Li₄Ti₅O₁₂ having a spinel structure. Note that the amount of solvent in the mixture is desirably between 2 wt % inclusive and 10 wt % inclusive, in case of adopting the bisphenol A type resin as the organic substance to be mixed with the lithium titanate.

### Example 2

There was obtained an electrochemical device-oriented electrode material according to the present invention in the same formulation as that of Example 1, except for adoption of a slurry-like mixture at a weight ratio of 19:12:3 of the lithium titanate, organic substance, and solvent. This is regarded as a present invention electrode material 2.

The electrode material looked black, and there were observed a peak of exothermic reaction and a commencement of weight decrease near 400° C. onward as a result of thermogravimetry/differential thermal analysis (TG-DTA). From the TG measurement result and an analysis result of outflow gas upon TG measurement, the present invention electrode material 1 was found to comprise lithium titanate with surfaces having 5.3 wt % of carbon material applied thereto. Additionally, as a result of specific surface area measurement by a BET one-point calibration curve method, the present invention electrode material 1 had a specific surface area of 57.4 m²/g, thereby showing that the same had an increased specific surface area about 17 times as large as that of the lithium titanate used as the starting material. Further, as a result of X-ray diffraction measurement, there was observed only a peak corresponding to Li₄Ti₅O₁₂ having a spinel structure.

(Measurement of Volume Resistivity)

Measurement of volume resistivity was conducted for the present invention electrode materials 1 and 2 and the comparative electrode material 1 in air at a temperature of 23° C. by the above-described measuring device. The measurement surfaces of the measurement proves were each 0.272 cm². Powder samples of electrode materials subjected to the measurement had masses of 0.35 to 0.40 g.

Table 1 shows volume resistivities measured for the present invention electrode materials 1 and 2 and the comparative electrode material 1, in relation to bulk density

TABLE 1

| | | Volume |
|---|---|---|
| | Bulk density | resistivity |
| | (g/cc) | (Ω · cm) |
| Example 1 | 1.54 | 12 |
| | 1.57 | 8 |
| | 1.61 | 7 |
| | 1.64 | 5 |
| | 1.68 | 4 |
| Example 2 | 1.61 | 16 |
| | 1.64 | 13 |
| | 1.68 | 9 |
| Comparative Example 1 | 1.57 | unmeasurable |
| | 1.61 | unmeasurable |
| Comparative Example 2 | 1.51 | 32 |
| | 1.55 | 28 |
| | 1.59 | 24 |
| | 1.63 | 20 |
| | 1.68 | 17 |
| Comparative Example 3 | 1.30 | 26 |
| | 1.32 | 22 |
| | 1.35 | 19 |
| | 1.39 | 18 |
| | 1.42 | 16 |

As apparent from these results, higher electrical conductivities were given to the present invention electrode materials 1 and 2 where carbon materials were applied to surfaces of lithium titanate particles. Note that values of volume resistivities of the comparative electrode material 1 were unmeasurable, since the values exceeded a measurement limitation (100 Ω·cm). As such, there were separately prepared the following two types of measurement samples.

### Comparative Example 2

The lithium titanate and acetylene black were dry mixed at a weight ratio of 9:1. This is regarded as a comparative electrode material 2.

### Comparative Example 3

The lithium titanate and acetylene black were dry mixed at a weight ratio of 8:1. This is regarded as a comparative electrode material 3.

Measurement of volume resistivity was conducted for the comparative electrode materials 2 and 3 in the same manner. The results are also shown in Table 1. From these results, it is understood that addition of larger amounts of acetylene black allows for certainly decreased volume resistivities, but simultaneously leads to lower bulk densities. In turn, addition of smaller amounts of acetylene black allows for restriction of decrease of bulk densities, but exhibits a limited effect for decreasing volume resistivities. Note that, when measurement for the comparative electrode materials 2 and 3 was conducted under a condition of more increased values of bulk densities, resistance values rather increased and exceeded the measurement limitation (100 Ω·cm), thereby failing to measure values of volume resistivities. Although the reason thereof is not necessarily apparent, this failure is assumed to be caused by breakage of chains serving for conduction of electrons of acetylene black due to excessive compression of each measurement sample. It is understood therefrom that mixtures of the lithium titanate and acetylene black never result in ones simultaneously having bulk densities of 1.5 g/cm³ or more and volume resistivities of 16 Ω·cm or less.

(Present Invention Electrode 1)

The present invention electrode material 1, acetylene black, and polyvinylidene fluoride (PVdF) were mixed with one another at a weight ratio of 80:10:10, followed by addition of N-methylpyrrolidone as a dispersion medium and by kneading and dispersing, thereby preparing a coating solution. Note that the PVdF was used in a form of solution including solid content dissolved and dispersed therein, and was evaluated in terms of solid content weight. The coating solution was coated onto an aluminum foil current collector having a thickness of 20 μm, and roll pressed, to fabricate a negative electrode plate having a thickness of 79 (±1) μm including the current collector. This is regarded as a present invention electrode 1.

(Comparative Electrode 1)

There was fabricated a comparative electrode 1 in the same formulation as that of the present invention electrode 1, except that the comparative electrode material 1, acetylene black, and polyvinylidene fluoride (PVdF) were mixed with one another at a weight ratio of 80:10:10.

(Fabrication of Electrochemical Device)

There was fabricated a positive electrode plate as follows. LiCoO₂, acetylene black, and polyvinylidene fluoride (PVdF) were mixed with one another at a weight ratio of 90:5:5, followed by addition of N-methylpyrrolidone as a dispersion medium and by kneading and dispersing, thereby preparing a coating solution. Note that the PVdF was used in a form of solution including solid content dissolved and dispersed therein, and was evaluated in terms of solid content weight. The coating solution was coated onto an aluminum foil current collector having a thickness of 20 μm, and pressed, to fabricate a positive electrode plate.

There was prepared a nonaqueous electrolyte, as follows. Lithium phosphate hexafluoride was dissolved at a concentration of 1 mol/l in a mixed solvent obtained by mixing ethylene carbonate, ethylmethyl carbonate, and dimethyl carbonate at a volume ratio of 6:7:7, thereby establishing a nonaqueous electrolyte (electrolytic solution).

Each negative electrode plate was opposed to an associated positive electrode plate via separator, to fabricate an electrochemical device. Here, the applicable negative electrode plate and positive electrode plate were cut out such that the negative electrode plate had an active area of 9 cm². Used as the separator was a microporous membrane made of polypropylene having a surface modified by polyacrylate to improve retentivity of electrolyte. Used as a sheath was a metal resin composite film made of polyethylene terephthalate (15 μm)/aluminum foil (50 μm)/metal adhesive polypropylene film (50 μm). Housed therein was a pair of applicable electrodes in a manner to externally expose open ends of a positive electrode terminal attached to the associated positive electrode plate and a negative electrode terminal attached to the associated negative electrode plate, followed by injection of the nonaqueous electrolyte and by airtight encapsulation. Note that there was provided a reference electrode made of metallic lithium, so as to monitor a single electrode behavior of the negative electrode plate. In this way, there was fabricated a lithium ion cell as an electrochemical device. Here, the electrochemical devices adopting the present invention electrode 1 and comparative electrode 1 as negative electrode plates are regarded as a present invention electrochemical device 1 and a comparative electrochemical device 1, respectively.

(Initial Charge and Discharge Test)

There was conducted an initial charge and discharge test of 5 cycles for each of the present invention electrochemical device 1 and the comparative electrochemical device 1. Charge at a first cycle was conducted at an electric current value of 0.1 ItA to the applicable negative electrode, until the negative electrode potential relative to the reference electrode was raised to 2.5V. Subsequent discharge was conducted at the same electric current value as the charge, until the voltage between the positive electrode and negative electrode was lowered to 2.5V. Charge and discharge at second through fifth cycles were conducted under the same condition as the first cycle, except that the electric current value to the applicable negative electrode was changed to 0.2 ItA. Further, at every cycle, there were set rest periods of 30 minutes upon changeover from charge to discharge and upon changeover from discharge to charge, respectively. Based on the discharge result at the fifth cycle, it was confirmed that a negative electrode capacity corresponding to a theoretical capacity (150 mAh/g) of lithium titanate was obtained in each of the present invention cell 1 and the comparative cell 1. Note that the discharge capacity at the fifth cycle is regarded as an “initial capacity”.

(Output Characteristic Test)

Subsequently, there was conducted an output characteristic test for the present invention electrochemical device 1 and the comparative electrochemical device 1. Discharge was conducted at various discharge rates from 0.2 It to 50 It from the applicable negative electrode. During discharge, there was monitored a negative electrode potential relative to the associated reference electrode, thereby evaluating a single electrode performance. There was provided a rest period of 30 minutes after completion of each discharge, and charge was conducted to the applicable negative electrode at an electric current value of 0.2 ItA until the negative electrode potential was raised to 2.5V relative to the associated reference electrode. There was obtained a discharge capacity under each discharge condition, in a percentage relative to the initial capacity, and this percentage is regarded as a “discharge capacity ratio (%)” relative to each discharge rate.

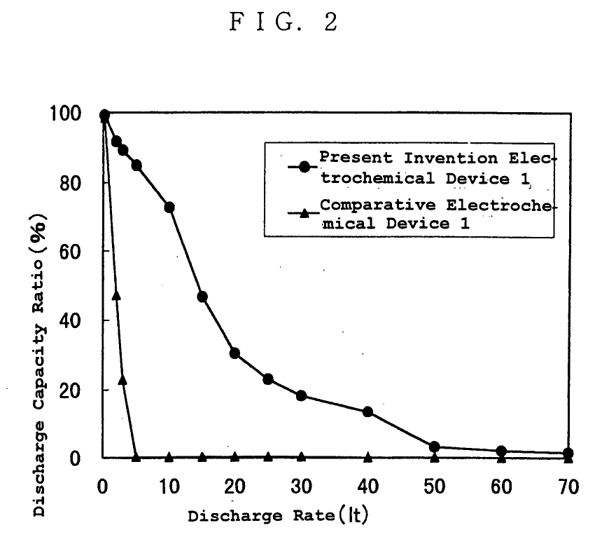

FIG. 2 shows a result of the output characteristic test. From the result of FIG. 2, it is understood that the present invention electrochemical device 1 has an output characteristic remarkably improved as compared with the comparative electrochemical device 1.

### Example 3

As an organic substance to be mixed with the lithium titanate, there was adopted a powder of polyvinyl alcohol resin (weight-average molecular weight of 1,500) such that the lithium titanate and 17% aqueous solution of the polyvinyl alcohol were mixed, to obtain a slurry-like mixture containing the lithium titanate, organic substance and water at a weight ratio of 1:1:5. Except for adoption of this mixture, there was obtained an electrochemical device-oriented electrode material according to the present invention in the same manner as Example 1. This is regarded as a present invention electrode material 3. Note that the concentration of the resin solution is desirably between 10 wt % inclusive and a saturation concentration inclusive, in case of adopting the polyvinyl alcohol resin as an organic substance to be mixed with the lithium titanate.

### Example 4

There was obtained an electrochemical device-oriented electrode material according to the present invention in the same manner as Example 1, except for adoption of a polyvinyl alcohol resin powder as an organic substance to be mixed with the lithium titanate without using a solvent, in a manner to adopt a mixture obtained by dry mixing the lithium titanate and the polyvinyl alcohol powder at a weight ratio of 1:1. This is regarded as a present invention electrode material 4.

The present invention electrode material 3 and present invention electrode material 4 were used to fabricate electrochemical devices, respectively, in the same formulation as that of the present invention electrochemical device 1. These are regarded as present invention electrochemical devices 3 and 4, respectively. There was conducted an initial discharge and charge test by using the present invention electrochemical devices 3 and 4 under the same condition as the above, and it was confirmed that a negative electrode capacity corresponding to a theoretical capacity (150 mAh/g) of lithium titanate was obtained in each of the present invention electrochemical device 3 and present invention electrochemical device 4. However, comparing negative electrode charge behaviors at the fifth cycle, the charge potential in the present invention electrochemical device 3 progressed extremely flatly at about 1.5V until achievement of about 90% of a charge capacity, whereas the flat discharge potential progress in the present invention electrochemical device 4 collapsed from near about 60% of the charge capacity such that a drop to a base potential was observed. Although the cause of this phenomenon is not necessarily apparent, it is assumed that the carbon material is arranged at surfaces of lithium titanate particles more uniformly in case of the present invention electrode 3 obtained by mixing the lithium titanate and the resin solution followed by subjection to the heat treatment in the presence of the solvent, than in case of the present invention electrode material 4 obtained by dry mixing the lithium titanate and the resin followed by subjection to the heat treatment. Based thereon, it is seen to be desirable to subject the mixture of the lithium titanate and the organic substance to the heat treatment process in the presence of a solvent, upon obtainment of the electrochemical device-oriented electrode material of the present invention by heat treatment.

### INDUSTRIAL APPLICABILITY

The electrode material, the electrode including the electrode material, the electrochemical device adopting the electrode, and the production method of the electrode material of the present invention, are all capable of utilizing the lithium titanate as an active material to provide an electrochemical device having a sufficient output characteristic, so that they are useful for: nonaqueous cells such as lithium primary cell, lithium secondary cell, and lithium ion cell; aqueous cells; fuel cells; electric double layer capacitors; and the like.

1. An electrochemical device-oriented electrode material, containing 90% or more of lithium titanate, and having a bulk density of 1.5 g/cm³ or more and a volume resistivity of 16 Ω·cm or less.

2. The electrochemical device-oriented electrode material of claim 1, wherein said electrochemical device-oriented electrode material includes lithium titanate particles on surfaces of which carbon materials are present.

3. The electrochemical device-oriented electrode material of claim 1, wherein the lithium titanate has a spinel structure and is represented by a composition formula of Li₄Ti₅O₁₂.

4. The electrochemical device-oriented electrode material of claim 2, wherein the lithium titanate has a spinel structure and is represented by a composition formula of Li₄Ti₅O₁₂.

5. An electrochemical device-oriented electrode including the electrochemical device-oriented electrode material of claim 1.

6. An electrochemical device adopting the electrochemical device-oriented electrode of claim 5.

7. A production method of an electrochemical device-oriented electrode material characterized in that the method comprises the steps of:
mixing lithium titanate with an organic substance into a mixture, and
conducting a heat treatment of the mixture, thereby obtaining the electrochemical device-oriented electrode material of claim 1.

8. The production method of an electrochemical device-oriented electrode material of claim 7, characterized in that the heat treatment is conducted by subjecting the mixture to a heat treatment process in the presence of a solvent.

9. The production method of an electrochemical device-oriented electrode material of claim 8, characterized in that the solvent is a nonaqueous solvent.

10. The production method of an electrochemical device-oriented electrode material of claim 7, characterized in that the organic substance has a phenolic structure.

11. The production method of an electrochemical device-oriented electrode material of claim 8, characterized in that the organic substance has a phenolic structure.
